(19) United States
(12) Patent Application Publication
(10) Pub. No.: US 2007/0011676 A1
(43) Pub. Date: Jan. 11, 2007

(54) Architecture and system for secure host management

(76) Inventors: Ravi Sahita, Beaverton, OR (US); Uri Blumenthal, Fair Lawn, NJ (US)

Correspondence Address: Buckley, Maschoff & Talwalkar LLC, Five Elm Street, New Canaan, CT, 06840, US

(21) Appl. No.: 11/170,925

(22) Filed: Jun. 30, 2005

(51) Int. Cl. G06F 9/46

(52) U.S. Cl. 718/100

(57) ABSTRACT

According to some embodiments, a resource data record associated with diagnostic code to manage a manageable resource is exposed, and the resource data record is discovered. The diagnostic code is loaded into a management platform based on the resource data record. The diagnostic code may be loaded from a location in host memory indicated by the resource data record. An the integrity check value may be received from the location in host memory, and an integrity check may be performed on the loaded diagnostic code based on the integrity check value.

### BACKGROUND

A conventional computing platform may include diagnostic code for managing a resource thereof. The diagnostic code exchanges information with instrumentation code associated with the managed resource. Management of the resource requires the diagnostic code to understand the structure and semantics of data exposed by the instrumentation code. In order to avoid writing dedicated diagnostic code for each resource of a particular type (e.g., a Network Interface Card device driver), conventional diagnostic code may be designed to semantically understand a superset of the data exposed for that resource across many versions (e.g., across different vendors) of the resource.

Windows Management Instrumentation (WMI), for example, defines one such framework for accessing information associated with managed resources. The WMI framework defines generic representations of systems, applications, networks, devices, and other manageable resources. Beyond a basic subset, however, it is infeasible to standardize such representations across various vendors of a same type of manageable resource.

### BRIEF DESCRIPTION OF THE DRAWINGS

FIG. 1 is a block diagram of a system according to some embodiments.

FIG. 2 is a flow diagram according to some embodiments.

FIG. 3 is a detailed block diagram of a system according to some embodiments.

FIG. 4 is a flow diagram according to some embodiments.

FIG. 5 is a block diagram illustrating operation of a system according to some embodiments.

FIG. 6 illustrates a Resource Data Record format according to some embodiments.

FIG. 7 is a block diagram of a system according to some embodiments.

### DETAILED DESCRIPTION

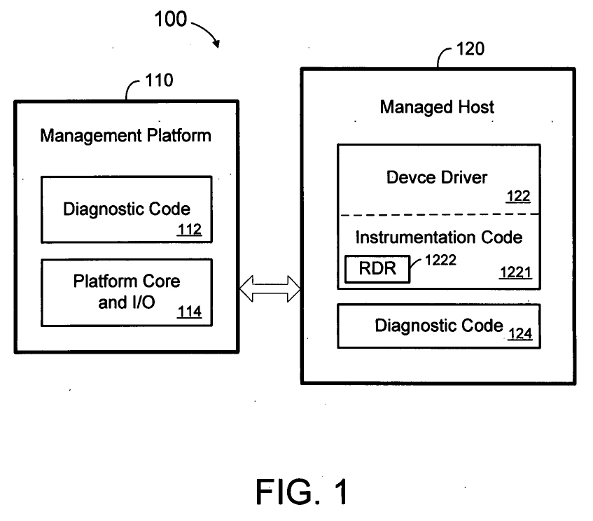

FIG. 1 illustrates system 100 according to some embodiments. System 100 includes management platform 110 and managed host 120. Management platform 110 may interact with sensors and effectors exposed by managed host 120 in order to manage managed host 120.

Management platform 110 includes diagnostic code 112 and platform core and input/output (I/O) module 114. Management platform 110 may execute diagnostic code 112 in conjunction with core and I/O module 114 to manage corresponding manageable resources of managed host 120.

Managed host 120 includes device driver 122 and diagnostic code 124. Device driver 122 includes instrumentation code 1221 and Resource Data Record (RDR) 1222. Managed host 120 executes instrumentation code 1221 to expose managed resource data associated with device driver 122. Instrumentation code 1221 and diagnostic code 124 may be particularly suited for interaction with one another. According to some embodiments that will be described in detail below, diagnostic code 112 of platform 110 is identical to diagnostic code 124, and is used to manage device driver 122.

RDR 1222 indicates a memory location in which diagnostic code 124 is stored. Management platform 110 may use RDR 1222 to locate and load diagnostic code 124 (i.e., diagnostic code 112) into management platform 110. More specifically, instrumentation code 1222 of device driver 122 may expose RDR 1222 to management platform 110. Management platform 110 then discovers RDR 1222, and uses the information therein to load diagnostic code 124 as diagnostic code 112.

Management platform 110 may comprise any one or more execution units including, but not limited to, a processor, a co-processor, a controller, one or more microengines of a network processor, a virtual machine, a logical partition, and a firmware extension. In some embodiments, management platform 110 may manage hardware and software resources of managed host 120 independent of an operating system environment provided by managed host 120.

In this regard, management platform 110 may provide an operating environment and memory separate those of managed host 120. Accordingly, some embodiments of management platform 110 may manage host 120 before boot, after shutdown, or post-crash of the operating system environment of managed host 120. The separate environment may provide security advantages over a management service running local to host 120. Specifically, a management service running on host 120 can be more easily compromised by a virus or worm attack if other resources on host 120 are compromised.

Managed host 120 may comprise any computing platform including one or more manageable resources. Managed host 120 may comprise a processor, a motherboard, a main memory, a chipset, a network interface card, other expansion cards, a power supply, a cooling system, and/or any other hardware components. Managed host 120 may also execute program code of an operating system, applications, and other device drivers. Any hardware, firmware, and software components of managed host 120 may comprise manageable resources.

A manageable resource may be associated with managed resource data comprising one or more sensors, effectors and events. For example, a fan's speed and a processor's temperature may comprise sensors associated with a fan resource and a processor resource, respectively. A packet count may comprise a sensor associated with a device driver for a network interface card. Values associated with each of these sensors may be stored in a memory location of managed host 120. According to some embodiments, diagnostic code of management platform 110 may manage a manageable resource by reading a sensor, configuring an effector, or subscribing to an event associated with the manageable resource.

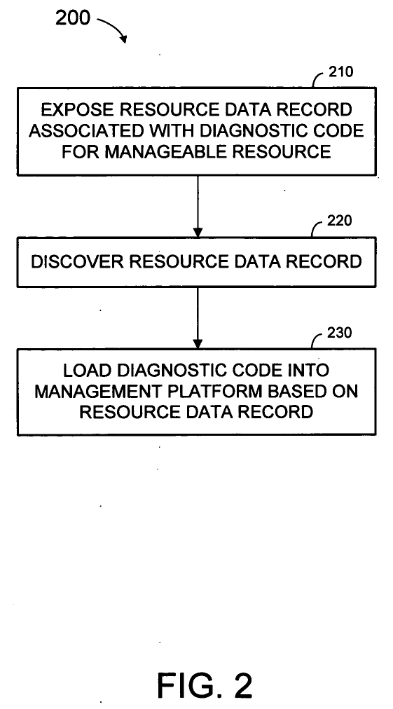

FIG. 2 is a flow diagram of method 200 according to some embodiments. Method 200 may be executed by, for example, a system such as system 100 of FIG. 1. Note that any of the methods described herein may be performed by hardware, software (including microcode), or a combination of hardware and software. For example, an execution unit may be operative in conjunction with program code stored on a storage medium to perform methods according to any of the embodiments described herein.

An RDR is initially exposed at 210. The RDR is associated with diagnostic code for a manageable resource. According to some embodiments, the RDR is exposed via a discovery protocol executed by device driver 122 and management platform 110. The RDR is discovered at 220 by a management platform, and indicates a memory location in which the diagnostic code is stored. As shown in FIG. 1, the memory location may be in the managed host that is associated with the manageable resource.

The diagnostic code is then loaded into the management platform at 230. Some examples of 230 include retrieving the diagnostic code using the memory location information of the RDR. The management platform may then execute the diagnostic code to manage the manageable resource. In some embodiments, the management platform may discover other RDRs associated with managed resource data of the manageable resource, and may retrieve the managed resource data from memory locations specified by the RDRs.

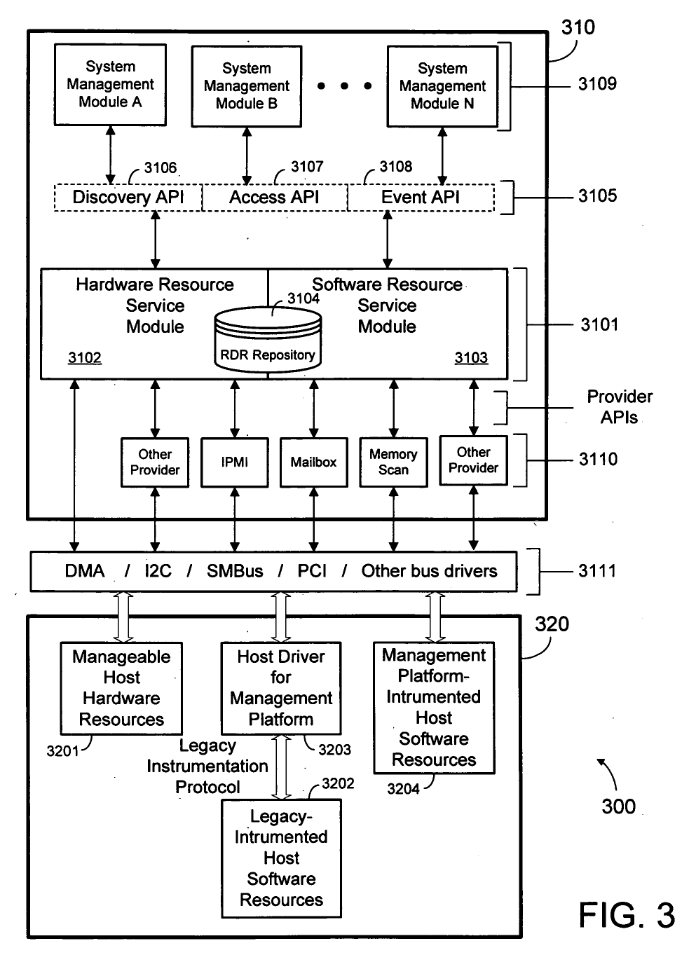

FIG. 3 comprises a detailed diagram of system 300 according to some embodiments. Management platform 310 and managed host 320 of system 300 comprises particular instantiations of management platform 110 and managed host 120 of FIG. 1. Accordingly, some embodiments of system 300 may provide the functions described above with respect to system 100. The elements of platform 310 and host 320 may be embodied as services, layers, and/or core components of an associated operating environment, and may be embodied as any other executable software component, including a dynamic link library, a static library or a stand-alone application.

Management platform 310 includes core 3101 comprising hardware resource service module 3102, software resource service module 3104 and RDR repository 3104. Core 3101 exposes external interface 3105, which includes Discovery application programming interface (API) 3106, Access API 3107, and Event API 3108. System management modules 3109 executing on management platform 310 invoke interface 3105 to read sensors, configure effectors, and subscribe to events associated with manageable resources of managed host 320. One or more of system management modules 3109 may comprise diagnostic code as described with respect to FIGS. 1 and 2.

System management modules 3109 may use Discovery API 3106 to dynamically discover what manageable resources are present in managed host 320. Such discovery allows modules 3109 to then invoke Access API 3107 to query for managed resource data associated with resources with which they wish to interact. Event API 3108 constitutes a set of APIs that would be used to subscribe to host-generated events and to publish events.

Resource service modules 3102 and 3103 handle sensor read/effector write/event subscription requests that are received via external interface 3105. Hardware resource service module 3102 interacts with managed resource data associated with manageable hardware resources 3201 on managed host 320 in response to invocations of interface 3105. Hardware resource service module 3201 may comply with existing protocols (e.g., Hardware Platform Interface, Intelligent Platform Management Interface) to interact with these resources either directly via an appropriate one of providers 3110 or via one of bus drivers 3111.

Software resource service module 3103 interacts with managed resource data associated with manageable software resources of host 320. Examples include network statistics associated with a network device driver, hard disk statistics associated with a hard disk driver, etc. Manageable software resources may comprise legacy-instrumented host software resources 3202 with which platform 310 interacts using corresponding platform software driver 3203, and/or host software resources 3204 that are instrumented in view of management platform 310 and may therefore directly interact therewith.

Modules 3102 and 3103 of core 3101 interact with manageable resources of host 320 via providers 3110. More particularly, modules 3102 and 3103 may use providers 3110 to access transport mechanisms of host 320 in order to reach managed resource data stored therein. Each of providers 3110 may abstract low-level communication with one or more corresponding bus drivers 3111 to a single provider API. For example, mailbox provider 3110 may expose a mailbox provider API to core 3101 for communication between core 3101 and two or more bus protocols. The number and type of providers in a given implementation of platform 310 may vary among embodiments.

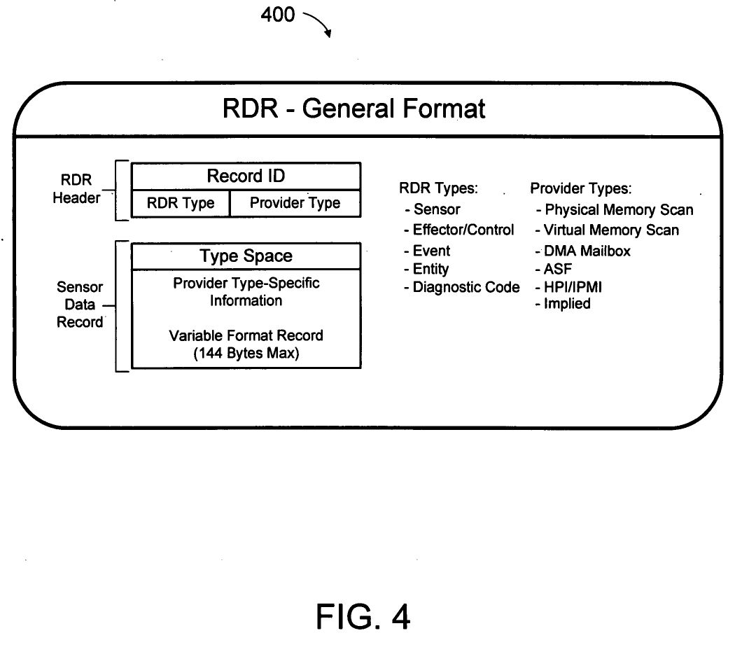

Resource service modules 3102 and 3103 are also responsible for discovering manageable resources on host 320. The discovered resources (specified in the form of RDRs) are stored in RDR repository 3104. RDRs may be used to provide a consistent mechanism for describing manageable resources, their relationships, and the operations that can be performed thereon. FIG. 4 is a representation of RDR 400 to illustrate a general RDR format according to some embodiments.

As shown, RDR 400 may describe managed resource data of a managed host. The description may include data type (i.e., RDR type) of the managed resource data, type of provider used to access the managed resource data (i.e., provider type), and other context information used by a provider to access a sensor, effector, event or diagnostic code associated with the RDR. Generally, a sensor RDR describes a resource capable of reading operational or health data (e.g. fan speed or Network Interface Card (NIC) statistics), an effector RDR describes a resource capable of platform control (e.g. powering on a fan or enabling a NIC's auto-negotiation feature), an event RDR describes resource's capability to generate asynchronous events, and a diagnostic code RDR describes diagnostic code to manage the manageable resource with which the RDR is associated. Sensor, effector, event, and diagnostic code RDRs logically belong to one “parent” entity RDR that identifies an associated manageable resource.

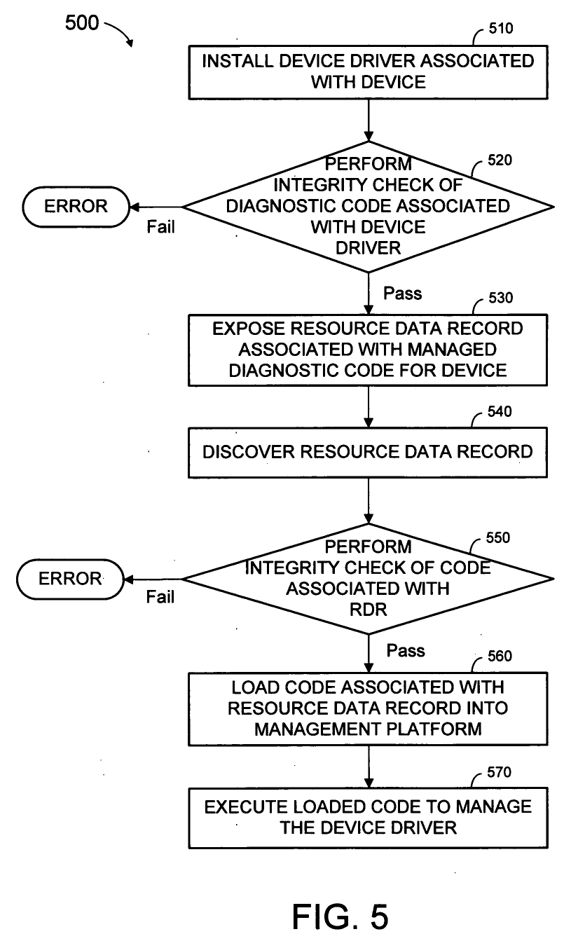

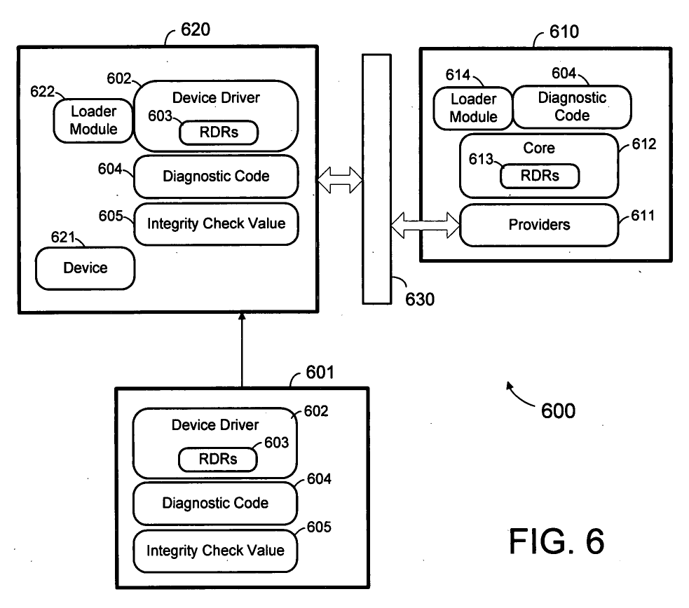

FIG. 5 is a flow diagram of method 500 according to some embodiments. Method 500 may be executed by, for example, systems such as systems 100 and/or 300. For illustration purposes, method 500 will be described with respect to system 600 of FIG. 6. System 600 includes software medium 601, management platform 610 and managed host 620.

Software medium 601 may comprise any medium for storing electronic data that is or becomes known. Non-exhaustive examples include a removable media storage medium such as a Compact Disc, a Digital Video Disc, a ZipT disk, a Universal Serial Bus drive, and an electromagnetic signal encoding the data.

Software medium 601 includes program code to provide device driver 602. Device driver 602 may comprise instrumentation code for exposing managed resource data associated with device driver 601, and RDRs 603 to describe at least a memory location of the managed resource data. Medium 601 also includes diagnostic code 604 for managing device driver 602 based on the exposed managed resource data.

Integrity check value 605 may comprise one or more values used to check the authenticity and/or integrity of elements 602 through 604 according to any suitable system or protocol. In some embodiments, integrity check value 605 comprises a hash based on one or more of elements 602 through 604. Integrity check value 605 may be encrypted using a symmetric key protocol. A decoding algorithm or decryption key corresponding to the algorithm or key used to create integrity check value 605 may be provisioned to managed host 620 prior to method 500 via any suitable out-of-band provisioning protocol.

Turning to method 500, a device driver associated with a device is installed at 510. The device driver may be installed using any currently- or hereafter-known system for driver installation. According to the FIG. 6 example, device 621 is newly-installed in an expansion slot of managed host 620. An operating system of host 620 recognizes the newly-installed device and asks an operator to specify a location of a corresponding device driver. The operator then points the operating system to device driver 602 of medium 601. Managed host 620 executes loader 622 to retrieve elements 602 through 605 from medium 601 and to install the elements on managed host 620. In some embodiments, device 621 is previously installed in managed host 620, and 510 comprises upgrading a device driver for device 621.

Installation at 510 may occur simultaneously with installation of the operating system according to some embodiments. In this regard, medium 601 may comprise an operating system installation medium, with elements 602 through 605 being installed along with the operating system installation.

An integrity check of the loaded diagnostic code is performed at 520. Loader 622 may perform the integrity check using integrity check value 605. According to some embodiments, loader 622 applies a pre-negotiated algorithm to loaded diagnostic code 604 and compares the result with loaded integrity check value 605. The integrity check may also include authentication of diagnostic code 604. Such authentication may comprise decrypting loaded integrity check value 605 with a pre-provisioned key prior to the above-described comparison. The integrity/authentication check of 520 may also evaluate device driver 602. An operating system error and/or appropriate management alerts may be generated if the check fails.

If the code passes the check, an RDR associated with the diagnostic code is exposed at 530 and discovered by management platform 610 at 540. According to some embodiments, the RDR is exposed via a discovery protocol executed by device driver 602. The discovery protocol may include an initialization phase in which device driver 602 of managed host 620 registers its associated management instrumentation data (i.e., managed resource data) using existing operating system-specific management instrumentation protocols. A host management driver (not shown) of managed host 620 then queries the protocol framework to identify the available management instrumentation data. In the case of the WMI protocol, such a query may comprise a query for all registered Globally Unique IDs. The host management driver then constructs an RDR repository in host memory based on the results of the query and on a pre-configured mapping between the operating-specific management instrumentation data type and the RDR type spaces.

The host management driver transmits a registration message through bus 630 and providers 611 to core 612 via a mailbox protocol to indicate that initialization is complete. In response to the message, core 612 queries the host management driver for the RDR repository in host memory. The host management driver returns the RDRs to core 612 in response to the query via the mailbox protocol at 540.

The above-described embodiment for RDR exposition and discovery utilizes operating system-specific management instrumentation protocols implemented by a software resource (e.g., device driver 602) as well as a host management driver to map operating-specific management instrumentation data type to RDR type spaces. Some embodiments, on the other hand, may provide discovery of manageable resources without such prerequisites.

For example, device driver 602 may allocate a host driver Direct Memory Access (DMA) window in host memory at 530. The window may comprise a contiguous, page-aligned and non-cached and non-paged memory location. Device driver 602 then updates the DMA window with resource-related information. The information may include a pre-defined marker identifiing the window and RDRs associated with the device driver 602. The RDRs include an RDR associated with diagnostic code 604 of host 620.

The DMA window may then be sent over a bidirectional mailbox protocol between managed host 620 and management platform 610. More specifically, according to some embodiments, device driver 602 registers the DMA window with a host management driver located on managed host 620, which in turn generates a device driver Id corresponding to device driver 602. The host management driver then allocates a host-to-management platform FIFO and a management platform-to-host FIFO for bidirectional communication between the managed host and the management platform.

The host management driver registers device driver 602 and the associated DMA window with management platform 610 by passing the device Id and the address of the DMA window via the host-to-management platform FIFO. A mailbox provider of providers 611 receives this information from the FIFO and passes it on to core 612. Core 612 then issues a command to scan the DMA window at the DMA window address.

A memory scan provider of providers 611 scans the DMA window to retrieve data therefrom. The data may comprise RDRs 603, which are stored in RDR repository 613 of management platform 610 in association with the previously-received device Id.

An integrity check is performed on diagnostic code associated with an RDR at 550. Some examples of 550 include executing loader 614 in conjunction with core 612 to identify an RDR associated with diagnostic code 604. The identified RDR includes a record ID that corresponds to device driver 602, a memory location of host 610 at which diagnostic code 604 resides, and a type of provider needed to access diagnostic code 604. Loader 614 then retrieves diagnostic code 604 from the memory location using the provider.

Next, loader 614 may perform the integrity check on diagnostic code 604 using integrity check value 605. In this regard, integrity check value 605 may be stored in association with diagnostic code 604 in host memory, and retrieved by loader 614 at 550. In some embodiments, loader 614 applies a pre-negotiated algorithm to diagnostic code 604 of management platform 610 and compares the result with retrieved integrity check value 605. The integrity check may also include authentication of diagnostic code 604 by decrypting the retrieved integrity check value 605 with a pre-provisioned key prior to the above-described comparison. An operating system error and/or management alert may be issued if the check at 550 fails. Loader 614 may also perform an integrity check on identified RDR prior to retrieving the diagnostic code.

The checked diagnostic code is loaded into the management platform at 560. Loader 614 may perform such loading after performing the integrity check at 550. The management platform may then execute the diagnostic code at 570 to manage the device driver. Such management may comprise retrieving managed resource data from memory locations specified by other RDRs associated with device driver 602 and discovered at 540.

In some embodiments of method 500, the described integrity checks may be performed based on different security associations. For example, integrity check value 605 may be based on a key shared between the operating system of host 620 and on the provider of driver 601. The DMA window mentioned above could also include a second integrity check value based on a key shared between host 620 and platform 610. Loader 614 may use the second integrity check value to verify the integrity of and/or authenticate the RDRs and other data of the DMA window. Moreover, a third integrity check value may be stored in the memory location of host 620 from which loader 614 retrieves diagnostic code 604. The third integrity check value may be based on a key shared between host 620 and platform 610 and may be used to verify the integrity and/or authenticate diagnostic code 605 at 560.

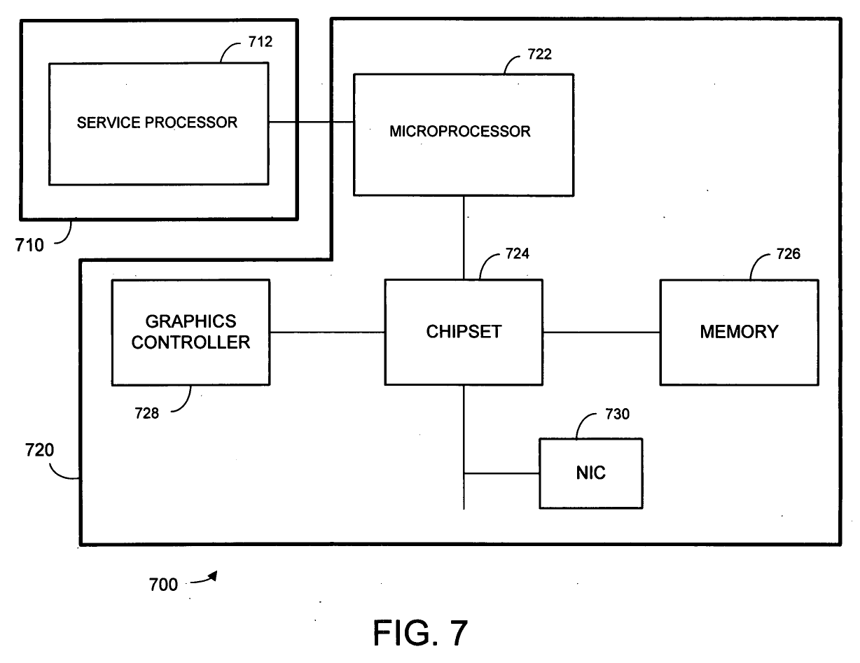

FIG. 7 illustrates a block diagram of system 700 according to some embodiments. System 700 includes management platform 710 and managed host 720. Management platform 710 includes service processor 712 which may execute functions attributed to a management platform herein. Managed host 720 comprises microprocessor 722, which may execute the host software described herein (e.g., device drivers, host management driver, etc.). Managed host 720 also includes chipset 724 and host memory 726. Host memory 726 may comprise any suitable type of memory, including but not limited to Single Data Rate Random Access Memory and Double Data Rate Random Access Memory. Other functional units of managed host 720 include graphics controller 728 and Network Interface Controller (NIC) 730, each of which may communicate with microprocessor 722 via chipset 724.

Some embodiments facilitate efficient interoperation of diagnostic code with instrumentation (i.e., managed resource data) exposed by a device driver via RDRs. Embodiments may also or alternatively provide tamper resistance to diagnostic code by using an RDR-based protocol to load the diagnostic code in an isolated execution engine of a management platform. Further aspects may facilitate device driver upgrades and/or patches since diagnostic code can be updated using the same framework that is used to update device driver code.

The several embodiments described herein are solely for the purpose of illustration. Therefore, persons in the art will recognize from this description that other embodiments may be practiced with various modifications and alterations.

What is claimed is:

1. A medium storing program code comprising:
code to provide a device driver, the device driver comprising a resource data record and instrumentation code for exposing managed resource data associated with the device driver; and
diagnostic code to access the managed resource data exposed by the instrumentation code and to perform a diagnostic function based on the accessed managed resource data,
wherein the resource data record indicates a memory location of the diagnostic code.

2. A medium according to claim 1, the device driver further comprising a second resource data record indicating a second memory location of the managed resource data.

3. A medium according to claim 1, the code further comprising:
an integrity check value to verify the integrity of the diagnostic code.

4. A medium according to claim 3, the code further comprising:
an integrity check value to verify the authenticity of the diagnostic code.

5. A medium according to claim 1, the code further comprising:
an integrity check value to verify the authenticity of the diagnostic code.

6. A medium according to claim 1, wherein the device driver is to be executed by a managed host, and
wherein the diagnostic code is to be loaded executed by a management platform.

7. A medium according to claim 6, wherein the management platform is to discover the resource data record, and to load the diagnostic code based on the memory location.

8. A medium according to claim 7, wherein the management platform is to verify the loaded diagnostic code.

9. A method comprising:
exposing a resource data record associated with diagnostic code, the diagnostic code to manage a manageable resource;
discovering the resource data record; and
loading the diagnostic code into a management platform based on the resource data record.

10. A method according to claim 9, further comprising:
exposing a second resource data record associated with managed resource data of the manageable resource, the second resource data record indicating a memory location of the managed resource data;
discovering the second resource data record;
accessing the managed resource data based on the second resource data record; and
process the managed resource data using the diagnostic code.

11. A method according to claim 9, the resource data record indicating a location of the diagnostic code in host memory, and
wherein the diagnostic code is loaded from the location.

12. A method according to claim 9, the resource data record indicating a location of the diagnostic code and an integrity check value in host memory.

13. A method according to claim 12, further comprising:
retrieving the integrity check value from the location in host memory; and
performing an integrity check on the loaded diagnostic code based on the integrity check value.

14. A method according to claim 12, further comprising:
retrieving the integrity check value from the location in host memory; and
authenticating the loaded diagnostic code based on the integrity check value.

15. A management platform comprising:
a memory storing executable program code; and
an execution unit operable in conjunction with the program code to:
discover resource data record associated with diagnostic code, the diagnostic code to manage a manageable resource;
load the diagnostic code based on the resource data record; and
manage the manageable resource based on the diagnostic code.

16. A management platform according to claim 15, the execution unit further operable in conjunction with the program code to:
discover a second resource data record associated with managed resource data of the manageable resource, the second resource data record indicating a memory location of the managed resource data;
access the managed resource data based on the second resource data record; and
process the managed resource data using the diagnostic code.

17. A management platform according to claim 15, the resource data record indicating a location of the diagnostic code in host memory, and
wherein the diagnostic code is loaded from the location.

18. A management platform according to claim 15, the resource data record indicating a location of the diagnostic code and an integrity check value in host memory.

19. A management platform according to claim 18, the execution unit further operable in conjunction with the program code to:
retrieve the integrity check value from the location in host memory; and
perform an integrity check on the loaded diagnostic code based on the integrity check value.

20. A management platform according to claim 18, the execution unit further operable in conjunction with the program code to:
retrieve the integrity check value from the location in host memory; and
authenticate the loaded diagnostic code based on the integrity check value.

21. A system comprising:
a processor;
a double data rate memory coupled to the processor;
a memory storing executable program code; and
a service processor operable in conjunction with the program code to:
discover resource data record associated with diagnostic code, the diagnostic code to manage a manageable resource;
load the diagnostic code based on the resource data record; and
manage the manageable resource based on the diagnostic code.

22. A system according to claim 21, the service processor further operable in conjunction with the program code to:
discover a second resource data record associated with managed resource data of the manageable resource, the second resource data record indicating a memory location of the managed resource data;
access the managed resource data based on the second resource data record; and
process the managed resource data using the diagnostic code.

23. A system according to claim 21, the resource data record indicating a location of the diagnostic code in host memory, and wherein the diagnostic code is loaded from the location.

24. A system according to claim 21, the resource data record indicating a location of the diagnostic code and an integrity check value in host memory.

25. A system according to claim 24, the execution unit further operable in conjunction with the program code to:
retrieve the integrity check value from the location in host memory; and
perform an integrity check on the loaded diagnostic code based on the integrity check value.
